(19) United States
(12) Patent Application Publication
(10) Pub. No.: US 2012/0085151 A1
(43) Pub. Date: Apr. 12, 2012

(54) METHOD AND APPARATUS FOR CHARACTERIZING POLYMERS

(75) Inventors: Stephan Konrad, Dormagen (DE); Stefanie Braun, Koln (DE); Johann Rechner, Kerpen (DE); Rainer Knopf, Krefeld (DE); Tom Foubert, Sint-Niklaas (BE); Franky Bruynseels, Sint Gillis-Waas (BE); Maarten De Bock, Kalmthout (BE)

(73) Assignee: Bayer MaterialScience AG, Leverkusen (DE)

(21) Appl. No.: 13/251,744

(22) Filed: Oct. 3, 2011

(30) Foreign Application Priority Data
Oct. 7, 2010 (EP) 10013391.7

(51) Int. Cl. G01N 11/02

(52) U.S. Cl. 73/54.02

(57) ABSTRACT

The present invention relates to a method for automatically determining the relative solution viscosity and/or the melt volume flow rate of a polymer, during a phase of the process for producing the polymer, where the polymer is in a solution with 10 to 20% by weight of the polymer in an organic solvent. The method includes continuously removing a substream of the polymer solution from a component of the process for producing the polymer, wherein the polymer solution is essentially free from inorganic salts; removing a sample having a volume of from 1 to 10 μl from the substream; introducing the sample into a gel permeation chromatography apparatus and determining the gel permeation chromatography data for the polymer; and automatically determining the relative solution viscosity and/or the melt volume flow rate of the polymer from the data obtained from the gel permeation chromatogram, on the basis of calibration relationships.

### CROSS REFERENCE TO RELATED APPLICATIONS

Priority is claimed to European Patent Application No. 10013391.7, filed on Oct. 7, 2010 which is incorporated herein by reference in its entirety for all useful purposes.

### BACKGROUND

The field of the invention relates to a method and an apparatus for automatically determining the solution viscosity and/or the melt volume flow rate (MVR) of polymers which are produced in solution, in particular of polycarbonates, by way of the gel permeation chromatography (GPC) method on samples which are removed directly from the process for to producing the polymers. In particular, the said method permits determination of solution viscosity and/or MVR of polymers, preferably polycarbonate (PC) which is removed directly from the interfacial process.

Solution viscosity and/or MVR are important parameters for characterizing polymers, in particular polycarbonates. In the industrial production of the polymers, it is important to measure the said properties at a very early stage in the production process, in order to permit intervention to regulate the production process if necessary.

Measurement of the relative solution viscosity (ηᵣₑₗ) of polymer solutions using the Ubbelohde viscometer, and measurement of melt volume flow rate (MVR), using melt index testing equipment, are established analytical methods for characterizing polycarbonate (Schnell, Hermann, Polymer Reviews. Vol. 9: Chemistry and Physics of Polycarbonates, 1964). Solution viscosity is determined to DIN 51562; MVR is determined to DIN EN ISO 1133. However, a major disadvantage of both methods for achieving the object is that it is practically impossible to carry out measurements on concentrated PC solutions. For a method that can measure solution viscosity on-line, the PC solution requiring testing would have to be diluted (to about 0.5% by weight). This implies additional cost for apparatus and control technology, for dilution of the PC solution sample removed from the PC production process and control to ensure that the concentration of the test sample is correct, and this analytical determination method is therefore unsuitable for achieving the object. For determination of an MVR value, the PC solution would first require complete drying. Again, this implies high additional cost.

The method according to the invention has therefore utilized size exclusion chromatography or gel permeation chromatography (GPC). By using calibration polymers of known molar mass and using an Ubbelohde viscometer to measure the solution viscosity of these and/or using melt index testing equipment to measure the MVR of these, it is possible to establish calibration relationships which permit conversion of data determined by the GPC method, for example on molecular weights, into solution viscosities and/or MVRs.

The use of the GPC method as an analysis method for the continuous monitoring of various production processes is in principle known, since the chromatography columns used for this purpose have already proven successful in the static “off-line” method with manual to application of the sample to the GPC column, and also in a wide variety of cases of multiple sequential analyses.

In methods known hitherto, the concentrated polymer-containing solvent phases have to be diluted before they are applied to the GPC column, if reproducible measurements are to be obtained. In the usual method, polycarbonate solutions comprising more than 10% by weight are diluted with the same solvent to markedly less than 1% by weight, preferably to 0.2% by weight, so that reproducible amounts of about 100 μl can be applied to the GPC column by way of a sample application system. However, if the said amounts of sample were metered onto a GPC column directly from the process, e.g. in the form of a polycarbonate solution of strength 16% by weight, the result would be complete overloading of the GPC column and no useful result, even if the high viscosity of the concentrated solution actually permitted reproducible application by the sample application system.

There has therefore been no lack of attempts to solve the said problem of automatic sampling and metering. WO 2001/083583 A1 describes, by way of example, an on-line measurement method for determining the molecular weight of PC from the interfacial process using GPC, and also describes the evaluation and transmission of the test data, extending as far as control of the reaction. However, the PC-containing solvent phase removed is not freed from residues of inorganic salts and from water. These ancillary constituents cause considerable disruption of the measurement of molecular weight on the GPC column, and impair the measurement result. Equally, there are no suitable commercial sample application systems which are capable of precise metering and injection of such highly concentrated solutions. WO 2001/083583 A1 gives no indication of any useful method of limiting the amount of sample at this type of high concentration, in order to obtain conclusive measurement results from the GPC method. Nor are there any further experimental data available in WO 2001/083583 A1, and no teaching leading to solution of the present object can therefore be found in that document.

U.S. Pat. No. 4,258,564 A describes an automated and continuous method for determining the molecular weight of polymers, e.g. polybutadiene, by the GPC method, and also an apparatus for the conduct of the said method. The said apparatus encompasses sample removal from the reactor, and also conveying of the sample to a metering valve, the dilution of a defined sample volume from the said metering valve with a solvent in a defined mutual ratio, and conveying of the dilute sample solution to a second metering valve which meters a precisely defined amount of the dilute sample solution onto the GPC column to determine the molecular weight. The final concentration of the dilute sample solution metered into the GPC column here is approximately of the same order of magnitude as that of the PC solution cited above and usually used for GPC measurements. The metered sample volumes, about 500 μl, are also of an order of magnitude similar to that of the PC solution volumes usually injected onto the GPC column. Since the aim is not, as in U.S. Pat. No. 4,258,564 A, to dilute samples removed from the PC reaction, the method described in that document is unsuitable for achieving the present object, because the additional cost for carrying out and controlling sample dilution makes an on-line analysis method expensive and unreliable.

U.S. Pat. No. 3,744,219 A likewise discloses a GPC analysis method which can be executed on-line, but this requires manual sample insertion. Devices known as “sample loops” are used for metering of a defined sample volume, where these are very small liquid-filled channels which have a definite volume, and a plurality of which are located between two valves, and can receive sample solutions. In accordance with principles identical with those in U.S. Pat. No. 4,258,564 A, the resultant defined amount of sample is displaced by solvent from the said channels and conveyed into the GPC column. However, the concentrations and the amounts of the samples to be measured on the GPC column are not disclosed. The arrangement of the channels between two valves is also very complicated and incurs additional control cost, and U.S. Pat. No. 3,744,219 A does not therefore provide any suitable approach to achieving the present object.

U.S. Pat. No. 5,462,660 A describes an apparatus for sampling and metering, for high-pressure liquid chromatography, which functions in accordance with principles identical with those previously described in U.S. Pat. No. 4,258,564 A and U.S. Pat. No. 3,744,219 A, involving metering valves and “sample loops”. However, the apparatus requires two 6-way valves and two pumps, and these increase control cost and the risk that the system will be unreliable.

WO 2000/20873 A1 describes, in the context of other analytical methods, a metering valve with a plurality of “sample loops” for treating a plurality of samples in succession, where syringes are used for sample injection into the metering valve, instead of the desired automatic sampling. Although the said process can meter very small amounts of sample from very narrow liquid channels, the technique described in that document is not adequate to achieve the present object.

Starting from the prior art described, an object is to provide a reliable analysis method of to maximum simplicity which is suitable for the automatic and continuous “on-line monitoring” of changes in the molecular weight structure of polymers, in particular of polycarbonate produced by the interfacial process, where these changes are to be identified as early as possible in the production process, in order that suitable changes in the control of the reaction can likewise be undertaken at an early stage.

It was therefore an object of the present invention to provide a simple, reliable, reproducible and efficient method that permits determination of the solution viscosity and/or the melt volume flow rate (MVR) of a polymer during the production process at short intervals, with a measurement frequency optimised to meet requirements.

### BRIEF DESCRIPTION OF PREFERRED EMBODIMENTS

It has now been found that by removing a polymer solution directly from the production process and, in contrast to the procedure that is otherwise usual, introducing it without further dilution to a GPC column for determining gel permeation chromatography data, for example on molecular weight, where the sample volume metered onto the GPC column is less than This applies in particular to a solution which has been substantially freed from residual salts and which has optionally been repeatedly washed with deionised water, and which has up to about 20% by weight polymer, preferably polycarbonate content, where this solution can be taken directly from the production process at a suitable site.

The manner of chromatographic separation of the various molar mass fractions of the polymer is identical with that used in the case of the conventional metering of relatively large amounts of dilute polymer solution, and the evaluation of the results of measurement is therefore problem-free, giving corresponding molar masses which can be converted into viscosity values and/or MVR. This is surprising to the extent that the metering of tiny amounts of highly concentrated samples (e.g. of 4 μl in comparison with relatively large amounts of sample of about 100 μl of dilute solution) would be expected to cause measurement problems, and could be problematic in respect of reproducibility and reliability.

The method avoids what are known as “off-line” analyses with sample transport to restricted-availability stationary equipment in laboratories, and with delays in feedback information. The gel permeation chromatography data, for example the molecular weights of the polymer produced, are stated in terms of solution viscosity value (relative solution viscosity ηᵣₑₗ) to DIN 51562, or melt volume flow rate (MVR) to DIN EN ISO 1133, for example at 300° C. with 1.2 kg load, since these types of information are features of the specification of commercially available polymer products, in particular commercially available polycarbonate products. The method permits determination of solution viscosity and/or MVR of the polymer from the gel permeation chromatography data, for example the molecular weights, on the basis of calibration relationships.

An embodiment of the present invention provides a method for automatically determining the relative solution viscosity and/or the melt volume flow rate of a polymer during a phase of the process for producing the polymer, wherein the polymer is in a solution comprising from 10 to 20% by weight of the polymer in an organic solvent, the method comprising:
a) removing a substream of the polymer solution from a component of the process for producing the polymer, wherein the polymer solution is essentially free from inorganic salts;
b) removing a sample having a volume of from 1 to 10 μl from the substream;
c) introducing the sample into a gel permeation chromatography apparatus and determining the gel permeation chromatography data for the polymer;
d) automatically determining the relative solution viscosity and/or of the melt volume flow rate of the polymer from the data obtained from the gel permeation chromatogram, on the basis of calibration relationships.

Another embodiment of the present invention provides an apparatus for determining the relative solution viscosity and/or the melt volume flow rate of a polymer, wherein the polymer is in a solution comprising from 10 to 20% by weight of the polymer in an organic solvent, comprising:
a) metering equipment for the precision conveying of a sample of the solution of the polymer having a defined volume in the range from 1 to 10 μl;
b) an apparatus for determining gel permeation chromatography data for the polymer;
c) means for determining the relative solution viscosity and/or the melt volume flow rate of the polymer from the data obtained from the gel permeation chromatogram, on the basis of calibration relationships.

Another embodiment of the invention provides an “on-line” method for determining molar mass distribution and the solution viscosity resulting therefrom, and/or the melt volume flow rate (MVR) of polymers, in particular of polycarbonates, where these occur in dissolved form, comprising the following steps:
i. continuous removal of a substream of a solution of the polymer requiring measurement in an organic solvent from a component of the production process for the polymer, where the said polymer solution is very substantially free from inorganic salts;
ii. removal of a sample with a volume of from 1 to 10 μl from the substream;
iii, optional return of the substream to the process for producing the polymer;
iv. introduction of the sample into a GPC measurement system and determination of gel permeation chromatography data, for example on the molecular weight M_{w} of the polymer, from the sample solution;
v. optional removal, from a feed vessel, of a calibration sample with a volume of from 1 to 10 μl of a solution of a polymer with known gel permeation chromatography data, e.g. M_{w}, ηᵣₑₗ and MVR, where the polymer concentration in the calibration sample is the same as the polymer concentration in the substream from the process for producing the polymer;
vi. optional introduction of the calibration sample into a GPC measurement system and determination of gel permeation chromatography data, for example on the molecular weight M_{w} of the polymer, from the calibration solution;
vii. automatic determination of the solution viscosity ηᵣₑₗ and/or the melt volume flow rate MVR of the sample from the gel permeation chromatography data measured, for example the molecular weight M_{w}, on the basis of calibration relationships.

The calibration sample involves a polymer with known M_{w}, ηᵣₑₗ and MVR and with known molecular weight distribution. An integral calibration process is carried out using the said calibration sample and suitable software. In one preferred embodiment, the calibration sample and the actual sample requiring measurement comprise the same polymer.

Some embodiments can also utilize other molecular weights, such as Mₙ or Mₚ, instead of M_{w}.

In one embodiment of the analysis method according to the invention, in order to simplify the method, a sample of the polymer solution is removed at a suitable site within the production process and is directly, and without further pretreatment such as purification or dilution, introduced into GPC analysis equipment, and measured. This makes the analysis method more reliable and enables dependable information to be provided in relation to gel permeation chromatography data, for example the molecular weights of polymers, expressed in terms of solution viscosity and/or MVR, at short intervals, an example being the determination of at least one measured value per hour. Features of the method according to the invention are the direct insertion and the accurate metering of very small amounts of the highly concentrated, washed polymer reaction solutions onto the GPC column without the otherwise conventional prior dilution of the samples.

The concentration of the polymer requiring measurement, e.g. of polycarbonate, in the solution in an organic solvent at room temperature (22° C.) is usually greater than 10% by weight, preferably being from 10 to 20% by weight and particularly preferably being from 14 to 18% by weight.

### BRIEF DESCRIPTION OF THE SEVERAL VIEWS OF THE DRAWING

The foregoing summary, as well as the following detailed description of the invention, may be better understood when read in conjunction with the appended drawings. For the purpose of assisting in the explanation of the invention, there are shown in the drawings representative embodiments which are considered illustrative. It should be understood, however, that the invention is not limited in any manner to the precise arrangements and instrumentalities shown.

In the drawings:

FIG. 1 illustrates the removal of a sample and the linkage to an analytical measurement system according to an embodiment of the present invention.

FIG. 2 illustrates the connection between analytical measurement system and the main stream by way of the sampling line according to an embodiment of the present invention.

### DETAILED DESCRIPTION OF THE PREFERRED EMBODIMENTS

As used herein, the singular terms “a” and “the” are synonymous and used interchangeably with “one or more” and “at least one,” unless the language and/or context clearly indicates otherwise. Accordingly, for example, reference to “a polymer” herein or in the appended claims can refer to a single polymer or more than one polymer. Additionally, all numerical values, unless otherwise specifically noted, are understood to be modified by the word “about.”

Suitable organic solvents for the polymer requiring measurement are in principle known and are used in the corresponding industrial production processes. Examples of suitable solvents for polymers, particularly for polycarbonate are halogenated hydrocarbons, e.g. methylene chloride, chloroform, mono- or dichloroethane, carbon tetrachloride, fluorinated chlorocarbons and chlorobenzene, or aromatic solvents, such as benzene, toluene and alkylbenzenes, or cyclic ethers, such as tetrahydrofuran and dioxane. Preferred solvents are methylene chloride and chlorobenzene. Particularly preferred solvents are mixtures made of methylene chloride and chlorobenzene. The situation with other polymers is similar.

The method is in principle applicable to any of the polymers which occur in dissolved form within the production process and the molecular weight distribution of which can be characterized with adequate precision by means of GPC analysis. Examples are polyacrylates, polystyrene or polyether ketones. In one embodiment, the method is applied to polymers, preferably polycarbonates which are produced by the interfacial process.

Polycarbonates are produced in a known manner from diphenols, carbonic acid derivatives, optionally chain terminators and optionally branching agents. Catalysts, solvents, work-up methods, reaction conditions, etc. for the production of polycarbonate by the interfacial process have been sufficiently described and are well known. Phosgene preferably serves as carbonic acid derivative. A portion of the carbonate groups in the polycarbonates suitable according to the invention, up to 80 mol %, preferably from 20 mol % up to 50 mol %, can have been replaced by aromatic dicarboxylic ester groups. Polycarbonates of this type, incorporating not only carbonic acid moieties but also moieties of aromatic dicarboxylic acids into the molecular chain, are strictly termed aromatic polyester carbonates. In the present application they would be subsumed under the generic term polycarbonates, for reasons of simplicity.

The average molecular weight M_{w} of the thermoplastic polycarbonates, where these are preferably used in the method according to the invention, inclusive of the thermoplastic, aromatic polyester carbonates, is from 12 000 to 120 000, preferably from 15 000 to 80 000 and in particular from 15 000 to 60 000, (determined by measuring the relative viscosity at 25° C. in CH₂Cl₂ at a concentration of 0.5 g per 100 ml of CH₂Cl₂).

Diphenols suitable for the process according to the invention for producing polycarbonate have been widely described in the prior art. Examples of suitable diphenols are hydroquinone, resorcinol, dihydroxybiphenyl, bis(hydroxyphenyl)alkanes, bis(hydroxyphenyl)cycloalkanes, bis(hydroxyphenyl) sulphides, bis(hydroxyphenyl)ethers, bis(hydroxyphenyl) ketones, bis(hydroxyphenyl) sulphones, bis(hydroxyphenyl) sulphoxides, α,α′-bis(hydroxyphenyl)diisopropylbenzenes, and also the (ring-)alkylated and ring-halogenated compounds derived therefrom.

Preferred diphenols are 4,4′-dihydroxybiphenyl, 2,2-bis(4-hydroxyphenyl)-1-phenylpropane, 1,1-bis(4-hydroxyphenyl)phenylethane, 2,2-bis(4-hydroxyphenyl)propane, 2,4-bis(4-hydroxyphenyl)-2-methylbutane, 1,3-bis[2-(4-hydroxyphenyl)-2-propyl]benzene (bisphenol M), 2,2-bis(3-methyl-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl) sulphone, 2,4-bis(3,5-dimethyl-4-hydroxyphenyl)-2-methylbutane, 1,3-bis[2-(3,5-dimethyl-4-hydroxyphenyl)-2-propyl]benzene and 1,1-bis(4-hydroxyphenyl)-3,3,5-trimethylcyclohexane (bisphenol TMC).

Particularly preferred diphenols are 4,4′-dihydroxybiphenyl, 1,1-bis(4-hydroxyphenyl)phenylethane, 2,2-bis(4-hydroxyphenyl)propane, 2,2-bis(3,5-dimethyl-4-hydroxyphenyl)propane, 1,1-bis(4-hydroxyphenyl)cyclohexane and 1,1-bis(4-hydroxyphenyl)-3,3,5-trimethylcyclohexane (bisphenol TMC).

These and other suitable dihydroxyaryl compounds have been described by way of example in DE-A 3 832 396, FR-A 1 561 518, in H. Schnell, Chemistry and Physics of Polycarbonates, Interscience Publishers, New York 1964, pp. 28 ff.; pp. 102 ff. and in D. G. Legrand, J. T. Bendler, Handbook of Polycarbonate Science and Technology, Marcel Dekker New York 2000, pp. 72 ff.

In the case of the homopolycarbonates, only one diphenol is used, but in the case of the copolycarbonates more than one diphenol is used, and although it is desirable here to use raw materials of maximum purity it is self-evident that, as is also the case with all of the other chemicals and auxiliaries added to the synthesis process, the diphenols used can have contamination by impurities deriving from the synthesis, handling and storage of the same.

The diaryl carbonates suitable for the reaction with the dihydroxyaryl compounds are those of the general formula (I)

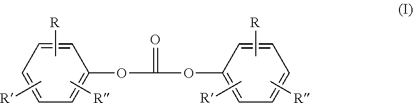

in which
R, R′ and R″ are mutually independently hydrogen, linear or unbranched C₁-C₃₄-alkyl, C₇-C₃₄-alkylaryl or C₆-C₃₄-aryl, and R can also be —COO—R′″, where R′″ is hydrogen, linear or branched C₁-C₃₄-alkyl, C₇-C₃₄-alkylaryl or C₆-C₃₄-aryl.

For the purposes of the invention, examples of C₁-C₃₄-alkyl are methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl, cyclohexyl, cyclopentyl, n-hexyl, 1,1-dimethylpropyl, 1,2-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl or 1-ethyl-2-methylpropyl, n-heptyl and n-octyl, pinacyl, adamantyl, the isomeric menthyl moieties, n-nonyl, n-decyl, n-dodecyl, n-tridecyl, n-tetradecyl, n-hexadecyl or n-octadecyl. The same applies to the corresponding alkyl moiety by way of example in aralkyl moieties or alkylaryl moieties, alkylphenyl moieties or alkylcarbonyl moieties. Alkylene moieties in the corresponding hydroxyalkyl or aralkyl or alkylaryl moieties are by way of example the alkylene moieties corresponding to the above alkyl moieties.

Aryl is a carbocyclic aromatic moiety having from 6 to 34 skeletal carbon atoms. The same applies to the aromatic portion of an arylalkyl moiety, also termed an aralkyl moiety, and also to aryl constituents of more complex groups, e.g. arylcarbonyl moieties.

Examples of C₆-C₃₄-aryl are phenyl, o-, p-, m-tolyl, naphthyl, phenanthrenyl, anthracenyl and fluorenyl.

Arylalkyl or aralkyl means independently a straight-chain, cyclic, branched or unbranched alkyl moiety as defined above which can have one, more than one or the maximum possible number of substituent aryl moieties according to the above definition.

Examples of preferred diaryl carbonates are diphenyl carbonate, methylphenyl phenyl carbonates and di(methylphenyl) carbonates, 4-ethylphenyl phenyl carbonate, di(4-ethylphenyl) carbonate, 4-n-propylphenyl phenyl carbonate, di(4-n-propylphenyl) carbonate, 4-isopropylphenyl phenyl carbonate, di(4-isopropylphenyl) carbonate, 4-n-butylphenyl phenyl carbonate, di(4-n-butylphenyl) carbonate, 4-isobutylphenyl phenyl carbonate, di(4-isobutylphenyl) carbonate, 4-tent-butylphenyl phenyl carbonate, di(4-tert-butylphenyl) carbonate, 4-n-pentylphenyl phenyl carbonate, di(4-n-pentylphenyl) carbonate, 4-n-hexylphenyl phenyl carbonate, di(4-n-hexylphenyl) carbonate, 4-isooctylphenyl phenyl carbonate, di(4-isooctylphenyl) carbonate, 4-n-nonylphenyl phenyl carbonate, di(4-n-nonylphenyl) carbonate, 4-cyclohexylphenyl phenyl carbonate, di(4-cyclohexylphenyl) carbonate, 4-(1-methyl-1-phenylethyl)phenyl phenyl carbonate, di[4-(1-methyl-1-phenylethyl)phenyl]carbonate, biphenyl-4-yl phenyl carbonate, di(biphenyl-4-yl) carbonate, 4-(1-naphthyl)phenyl phenyl carbonate, 4-(2-naphthyl)phenyl phenyl carbonate, di[4-(1-naphthyl)phenyl]carbonate, di[4-(2-naphthyl)phenyl]carbonate, 4-phenoxyphenyl phenyl carbonate, di(4-phenoxyphenyl) carbonate, 3-pentadecylphenyl phenyl carbonate, di(3-pentadecylphenyl) carbonate, 4-tritylphenyl phenyl carbonate, di(4-tritylphenyl) carbonate, methyl salicylate phenyl carbonate, di(methyl salicylate) carbonate, ethyl salicylate phenyl carbonate, di(ethyl salicylate) carbonate, n-propyl salicylate phenyl carbonate, di(n-propyl salicylate) carbonate, isopropyl salicylate phenyl carbonate, di(isopropyl salicylate) carbonate, n-butyl salicylate phenyl carbonate, di(n-butyl salicylate) carbonate, isobutyl salicylate phenyl carbonate, di(isobutyl salicylate) carbonate, test-butyl salicylate phenyl carbonate, di(tert-butyl salicylate) carbonate, di(phenyl salicylate) carbonate and di(benzyl salicylate) carbonate.

Particularly preferred diaryl compounds are diphenyl carbonate, 4-tert-butylphenyl phenyl carbonate, di(4-tert-butylphenyl) carbonate, biphenyl-4-yl phenyl carbonate, di(biphenyl-4-yl) carbonate, 4-(1-methyl-1-phenylethyl)phenyl phenyl carbonate, di[4-(1-methyl-1-phenylethyl)phenyl]carbonate and di(methyl salicylate) carbonate. Diphenyl carbonate is very particularly preferred. It is possible to use either one diaryl carbonate or else various diaryl carbonates.

The amount used of the diaryl carbonate(s), based on the dihydroxyaryl compound(s), is generally from 1.02 to 1.30 mol, preferably from 1.04 to 1.25 mol, particularly preferably from 1.045 to 1.22 mol, very particularly preferably from 1.05 to 1.20 mol, per mole of dihydroxyaryl compound. It is also possible to use mixtures of the abovementioned diaryl carbonates, and the molar amounts listed above per mole of dihydroxyaryl compound then refer to the total molar amount of the mixture of the diaryl carbonates.

The monofunctional chain terminators needed to regulate the molecular weight in the interfacial process, an example being phenol or alkylphenols, in particular phenol, p-tert-butylphenol, isooctylphenol, cumylphenol, chlorocarbonic esters of these, or acyl chlorides of monocarboxylic acids or, respectively, mixtures of the said chain terminators, are either introduced to the reaction with the bisphenolate(s) or else are added at any desired juncture of the synthesis process, as long as phosgene or chlorocarbonic acid terminal groups are still present in the reaction mixture or, respectively, in the case of the acyl chlorides and chlorocarbonic esters as chain terminators, as long as there are sufficient phenolic terminal groups available on the polymer that is being formed. However, it is preferable that the chain terminator(s) is/are added after the phosgenation process at a location or at a juncture at which no residual phosgene is present, but the catalyst has not yet been added. As an alternative, they can also be added prior to the catalyst, together with the catalyst, or in parallel.

Branching agents or branching agent mixtures are optionally added in the same manner to the synthesis process. However, branching agents are usually added before the chain terminators. The compounds generally used comprise trisphenols, quaterphenols or acyl chlorides of tri- or tetracarboxylic acids, or mixtures of the polyphenols or of the acyl chlorides. Examples of some of the compounds that are suitable as branching agents, having three or more phenolic hydroxy groups, are phloroglucinol, 4,6-dimethyl-2,4,6-tri(4-hydroxyphenyl)-2-heptene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis(4,4-bis(4-hydroxyphenyl)cyclohexyl]propane, 2,4-bis(4-hydroxyphenylisopropyl)phenol, and tetra(4-hydroxyphenyl)methane. Some of the other bifunctional compounds are 2,4-dihydroxybenzoic acid, trimesic acid, cyanuric chloride and 3,3-bis(3-methyl-4-hydroxyphenyl)-2-oxo-2,3-dihydroindole. Preferred branching agents are 3,3-bis(3-methyl-4-hydroxyphenyl)-2-oxo-2,3-dihydroindole and 1,1,1-tri(4-hydroxyphenyl)ethane.

The catalysts preferably used in the interfacial synthesis of polycarbonate are tertiary amines, in particular triethylamine, tributylamine, trioctylamine, N-ethylpiperidine, N-methylpiperidine, N-iso/n-propylpiperidine, quaternary ammonium salts such as tetrabutylammonium hydroxide, chloride, bromide, hydrogensulphate, and tetrafluoroborate, and the corresponding tributylbenzylammonium and tetraethylammonium salts, and also the phosphonium compounds corresponding to these ammonium compounds. These compounds are described in the literature as typical interfacial catalysts and are commercially available and are familiar to the person skilled in the art. The catalysts can be added into the synthesis process individually, in a mixture or else alongside one another or in sequence, also if appropriate prior to the phosgenation process, but preference is given to additions after introduction of the phosgene, except when the catalysts used comprise an onium compound or a mixture of onium compounds. In that case, addition prior to addition of the phosgene is preferred. The catalyst(s) can be added undiluted, in an inert solvent, preferably the solvent for the polycarbonate synthesis, or else in the form of aqueous solution, and in the case of the tertiary amines the addition then takes the form of ammonium salts of these with acids, preferably mineral acids, in particular hydrochloric acid. If a plurality of catalysts are used, or portions of the total amount of catalyst are added, it is also, of course, possible to use different addition methods at different locations or at different times.

The total amount used of the catalysts is from 0.001 to 10 mol % based on moles of bisphenols used, preferably from 0.01 to 8 mol %, particularly preferably from 0.05 to 5 mol %.

The polymer, preferably polycarbonate solution requiring measurement in an organic solvent is removed from the process for producing the polymer, preferably polycarbonate by the interfacial process at a site not prior to that at which the polymer, preferably polycarbonate solution has been freed from the aqueous phase of the fully reacted reaction mixture, since the presence of the strongly alkaline salt-containing aqueous phase would disrupt size exclusion chromatography on the GPC column). The organic polymer, preferably polycarbonate-containing solvent phase separated off from the aqueous reaction phase always comprises residual content of water and of inorganic salts, and it is therefore advantageous for the GPC measurement method to use suitable measures for substantial removal of content of this type.

It is of no importance here whether the said purification measures for the organic phase are used during the conventional course of the process for producing the polymer, preferably polycarbonate by the interfacial process or whether they are specifically used only on the polymer solution sample, preferably polycarbonate solution sample removed. An example of purification measures of this type applied to the polymer solution, preferably polycarbonate solution is washing with deionised water, with intensive mixing, and subsequent separation of the two phases, and these two processes can also be repeated more than once. Examples of suitable apparatuses for the phase-mixing process are centrifugal pumps, stirred apparatuses or static mixers, and combinations thereof; and examples of suitable apparatuses for the phase-separation process are decanters that use gravity, centrifuges or coalescers and combinations thereof. The same applies analogously to other production processes for polymers where inorganic salts are present in the polymer.

Examples of other purification measures for the organic polymer phase are treatment with ion exchangers to remove salts, and treatment with adsorbents, such as activated charcoal, zeolites or kieselguhr to adsorb salts and water.

It is preferable that the polymer, preferably polycarbonate solution for sampling for the GPC measurement method is removed from the process for producing the polymer, preferably polycarbonate in the section of the process where the organic polymer, preferably polycarbonate phase is washed with deionised water. It is particularly preferable to remove the sample after repeated washing of the organic polymer, preferably polycarbonate phase with deionised water, at the site at which the electrical conductivity of the aqueous phase separated off from the organic polymer, preferably polycarbonate solution is less than 5 μS.

The analysis method according to the invention can be conducted using the apparatus described hereinafter. Polymer solution samples are automatically removed here at prescribed, but variably adjustable, intervals from the process for producing the polymer, and are subjected to measurement in such a way as to permit (by way of gel permeation chromatography data) checking of the molecular weight of the polymer in accordance with requirements, and thus also checking of the solution viscosity of the polymer. This type of checking in accordance with requirements is intended to provide maximum speed of recognition of either unplanned or planned changes in molar masses of the polymer or solution viscosities of the polymer, either in the steady-state production process or in the event of a planned change of reaction parameters, thus providing an option of maximum speed of corrective intervention through targeted change of reaction parameters.

The said correction of reaction parameters, which is targeted and rapid when required, is provided inter alia through suitable intervals between two successive polymer samplings from the process for producing the polymer. However, the regular interval between two such samplings should normally be no more than 2 hours, preferably no more than 1 hour. In the event of changeovers between the type of polymer produced, or in the event of targeted interventions into the reaction, the interval between two samplings should be smaller than 1 hour, preferably smaller than half an hour.

The time required for a sample to pass completely through the analysis process according to the invention, from sampling from the process for producing the polymer as far as output of the resultant measurement in the form of a solution viscosity ηᵣₑₗ and/or MVR of the polymer sample, is from 1 to 120 min, preferably from 2 to 60 min. In order to permit removal and measurement at short intervals of samples from the process for producing the polymer, more than one GPC system can be operated in parallel, and sample injection onto the next independent GPC system can be begun before the first GPC system has finished the molar mass separation process. If the level of chronological resolution required is lower, it is also possible to apply polymer solutions from various reactions within a production site in succession to a single GPC system. The ratio of polymer solutions from different reactions to GPC systems can be varied according to requirement in respect of chronological resolution and precision of measurement, in the range from 10:1 to 1:10. Ratios of from 5:1 to 1:5 are preferred, and ratios of from 3:1 to 1:3 are particularly preferred.

The calculation of polymer solution viscosities, in particular of polycarbonate solution viscosities, in the form of values for ηᵣₑₗ, or of melt volume flow rates (MVR), from the data determined by GPC, for example the molar masses of the polymers, is based on calibration to relationships. MVR and ηᵣₑₗ values have excellent correlation with measured Mₙ and M_{w} values of polymer, preferably polycarbonate, and it is therefore possible to use an M_{w} value measured on-line to predict the determined to DIN 51562 and/or the MVR determined to DIN EN ISO 1133 for the polymer produced. In one preferred embodiment of the analysis method according to the invention, this calibration relationship has been stored in software in a suitable apparatus, in such a way that an automatic link between the value measured by GPC for the molar mass M_{w}, and the associated solution viscosity ηᵣₑₗ or the associated MVR can be generated and displayed.

The invention further provides an apparatus for the conduct of the inventive analysis process, encompassing means for sampling from the production process, metering equipment for the precision conveying of precisely defined very small amounts of sample, at least one apparatus for conduct of the gel chromatography process, and the hard- and software required for the control of the analysis process and for the evaluation of the results of measurement.

In one embodiment, the apparatus according to the invention comprises at least one line for removing the solution of the polymer requiring measurement in an organic solvent from a portion of the plant for the process for producing the polymer, in particular a process for producing polymers, particularly polycarbonate, where the said polymer solution has been very substantially freed from inorganic salts. There is advantageously a connection between the sampling line and the main stream of the production plant and the analysis equipment inclusive of the sampling system, in such a way that removal of the polymer solution takes place continuously within the ancillary stream from the main stream.

In the case of sample removal of a polymer solution from an interfacial process, in particular a polycarbonate solution from the washing section of the process by way of the sampling line to the valve, the pressure prevailing in the said line is the pressure of the separation apparatus which separates the organic polymer solution from the aqueous washing phase. This pressure is generally sufficient to ensure the continuous transport of organic polymer solution through the sampling line to the valve, and no separate pump is therefore required for the said transport. However, a conveying pump can be present if required.

In one embodiment, the apparatus according to the invention comprises at least one sample loop, for separating a defined volume of from 1 to 100 ml from the sampling line by way of a plurality of 3-way valves. The sample loop is delimited by two 3-way valves set in such a way that either sample flows continuously through the sample loop or the polymer solution located in the sample loop is transferred to the analytical multiway valve. There is a further line present for pure organic solvent; this line is subject to the superatmospheric pressure generated by a solvent pump and likewise has connection to one of the 3-way valves, in order to permit transfer of the polymer solution.

In one embodiment, the apparatus according to the invention comprises an apparatus for removing, from a feed vessel, an organic solution of a polymer with known gel permeation chromatography data, e.g. M_{w}, ηᵣₑₗ, and MVR in a concentration the same as that of the polymer solution from the production process, e.g. with the aid of a suitable pump.

In one embodiment of the apparatus according to the invention, the metering equipment for the precision conveying of precisely defined very small amounts of sample encompasses an analytical multiway valve (5- or 6-way valve) which comprises, or has connection to, one or more sample loops which can provide precise metering of sample volumes in the range from 1 μl to 10 μl.

In one embodiment, the analytical multiway valve comprises an injection loop for the GPC system with a volume in the range from 1 μl to 10 μl, or has an externally arranged injection loop with a volume in the range from 1 to 10 μl There are various valve positions of the analytical multiway valve. In one defined valve position, a polymer solution intended for measurement can flow continuously through an injection loop. In another defined valve position, the polymer solution intended for measurement and present in the injection loop can be forced out of the injection loop and conveyed into a line which has connection to the GPC system (or the GPC columns). In another defined valve position, pure solvent can flow continuously through the injection loop, which is thus flushed. In one embodiment, the said flushing solution is collected separately.

In one embodiment, the analytical multiway valve involves a cylindrical or spherical valve core mounted rotably in a valve seat which fits therewith and provides a leak proof seal, where both the valve core and the valve seat comprise a plurality of drilled holes. The drilled holes in valve core and valve seat can be positioned opposite to one another by suitable rotation of the valve core in such a way as to generate the required connections between drilled holes in the valve seat and drilled holes in the valve core, thus enabling the functions described above. An adequate seal between valve core and valve seat ensures that no significant leakage flows occur in any unintended direction. This type of multiway valve can be, for example, a 5-way valve or else a 6-way valve. Valves of this type are well known to the person skilled in the art.

In one embodiment of the multiway valve, there is a plurality of sample loops arranged in the form of narrow channel-like drilled holes within the valve core, connecting two adjacent openings in the valve core to one another. In the case of a 6-way valve, there are three sample loops of equal size present within the valve core, and these respectively have connection to two of six openings in the valve seat. There are passages connecting the six openings in the valve seat, and each of the pairs, prescribed by the design of the valve, of adjacent passages in the valve seat are continuously connected to one another via a respective sample loop within the valve core. The arrangement of the passages at the six openings in the valve seat here is such that the polymer solution flows through one of the sample loops, one of the sample loops is evacuated in the direction of the GPC column, by using solvent, and one of the sample loops is flushed and evacuated into a waste vessel, by using solvent.

Other embodiments can use multiway valves which have connection to sample loops situated outside of the valve, instead of sample loops installed within the valve core. The mode of operation of a multiway valve depends here on whether the sample loop has been arranged within or outside of the valve.

These valves and sample loops are in principle known and commercially available. Examples of suitable multiway valves are ETC6UW or EDC6UW from Valco Instruments Co. Inc., VICI AG International, 8300 Waterbury, Houston, Tex. 77055, USA, or MX switching valves from IDEX Health & Science LLC, 600 Park Court, Rohnert Park, Calif. 94928, USA (e.g. No. 447900). The volume of the sample loops is from 1 to 10 μl, preferably from 3 to 7 μl. By way of example, stainless steel capillaries of appropriate length can be used for this purpose, with external diameter 1/16″ and internal diameter from 100 to 250 μm.

For conveying the pure solvent needed for the transfer of the highly concentrated polymer solution from the ancillary stream into the injection loop, one embodiment uses a pump suitable for HPLC, e.g. a high-pressure double-piston pump, capable of conveying at a gauge pressure up to 600 bar.

In one embodiment, the apparatus according to the invention comprises one or more GPC systems to be operated in parallel, with all of the necessary equipment for conduct of the gel chromatography measurement process and determination of the various gel permeation chromatography data, for example the molecular weights M_{w}, Mₙ, or Mₚ of the polymer from the sample solution.

The GPC system, of which there can also be more than one, thus allowing time-shifted parallel operation of measurements, for example in the event of increased sampling frequency, can encompass one or more commercially available GPC columns arranged in series for size-exclusion chromatography, where the selection of these is such as to permit adequate separation of the molar masses of polymers, in particular of aromatic polycarbonates with weight-average molar masses M_{w} of from 5000 to 100 000 g/mol.

One embodiment uses a plurality of analytical columns arranged in series with diameter 7.5 mm and length 300 mm. The particle sizes of the column material are in the range from 3 to 20 μm. The selection of the columns is to be such that the differences between the ηᵣₑₗ and MVR values to be determined from the gel permeation chromatography data for the various products to be produced can be detected with adequate certainty. If, by way of example, the M_{w} values are utilised for calculating ηᵣₑₗ and MVR, the differences between the corresponding M_{w} values must be detectable with adequate reliability. If, by way of example, various polymers are produced and the average molecular weight M_{w} of these differs by 1000 g/mol, this difference must be reliably distinguishable with the aid of the GPC system used. Stringent requirements are therefore placed on the accuracy of the GPC system, and especially on its precision.

The eluent used comprises suitable organic solvents, e.g. THF, chloroform or dichloromethane. One embodiment uses dichloromethane. Suitable pumps are the typical pumps used for high-pressure liquid chromatography, e.g. high-pressure double-piston pumps, where these provide very constant and precise flow rate through the GPC columns. Detectors that can be used comprise refractive index detectors (RI), UV detectors, evaporation light scattering (ELS) detectors, viscosity detectors, (e.g. a viscometer using one, two or four capillaries) or scattered light detectors. Preference is given to UV detectors and RI detectors.

The GPC system is calibrated with polymers of known molar masses and/or molar mass distributions, e.g. with known Mₚ values. It is preferable to use polycarbonates or polystyrenes. Polymer solutions of these are prepared with a concentration corresponding to the production process, and these are fed into the sampling line with the aid of a suitable pump, e.g. a diaphragm pump, instead of the polymer solution from the production process. In one embodiment, a computer is used to control the feed either of a sample from production or of a calibration sample into the sampling line.

The GPC system can have an additional automatic sample input device which can inject dilute polymer solutions, e.g. for testing of the system.

For the control of the GPC system, inclusive of the multiway valve for the injection process, and for the evaluation of the chromatograms, it is preferable to use methods known to the person skilled in the art, employing a computer and suitable software, e.g. PSS WinGPC Unity.

In one embodiment, the apparatus according to the invention comprises further apparatuses for calculating and displaying the solution viscosity ηᵣₑₗ and/or the melt volume flow rate MVR of the polymer sample tested, on the basis of calibration relationships.

In one embodiment, the apparatus according to the invention comprises control apparatuses for the fully automatic continuous regulation of the timing of calibration, sampling, actuation of all of the valves, sample metering into the GPC system, initiation of the GPC measurement process, flushing of the sample loop, display and/or documentation of the resultant measurement, and resampling.

In one embodiment, the apparatus according to the invention encompasses the following components:
a) a sampling line for the solution of the polymer requiring measurement in an organic solvent from a component of the polymer production process, where the said polymer solution is very substantially freed from inorganic salts, and where the said line is subject to superatmospheric pressure and has connection to the valve, and permits removal of the polymer solution in the substream from the main stream. The sampling line is intended to separate off a defined volume by way of valves. The volume that can be separated in this way is termed sample loop.
b) a calibration apparatus which allows the organic solution of a polymer with known gel permeation chromatography data, e.g. M_{w}, ηᵣₑₗ and MVR, at a concentration the same as that of the polymer solution from the production process, to be pumped into the sampling line with the aid of a suitable pump, instead of the polymer solution from the production process.
c) a line for pure organic solvent; this line is subject to the superatmospheric pressure generated by a solvent pump and also has connection to the valve by way of the sampling line described in a).
d) an analytical multiway valve which comprises an injection loop for the GPC system or has connection to an externally arranged injection loop in such a way that, if the valve is in a defined position, the polymer solution requiring measurement in an organic solvent can flow continuously through the said injection loop, where the said injection loop has a precisely defined volume of from 1 to 10 and in another defined valve position the polymer solution requiring measurement and present in the injection loop can be forced out of the injection loop by the superatmospheric pressure of a solvent and can be conveyed into a line which has connection to the GPC system, and in another defined valve position pure solvent flows continuously through the injection loop, which can thus be flushed, where this flushing solution is collected separately.
e) a line from the valve d) to the GPC system, where the precisely defined volume of the PC solution requiring measurement from the injection loop is conveyed in the line with the aid of the superatmospheric pressure of pure solvent to the ingoing end of the GPC system, which is ready for operation.
f) a GPC system, or optionally a plurality of GPC systems to be operated in parallel, with all of the necessary equipment for conduct of the gel chromatography measurement process and determination of the gel permeation chromatography data, for example the variously defined molecular weights M_{w}, Mₙ, Mₚ, and D of the polymer from the sample solution.
g) further apparatuses for the continuous calculation and display of the solution viscosity ηᵣₑₗ and/or the melt volume flow rate MVR from the gel permeation chromatography data, for example from the molecular weights of the polymer sample measured, on the basis of calibration relationships.
h) control apparatuses for the fully automatic continuous regulation of the timing of sampling, sample metering into the GPC system, initiation of the GPC measurement process, flushing of the sample loop, display and/or documentation of the resultant measurement, and resampling.

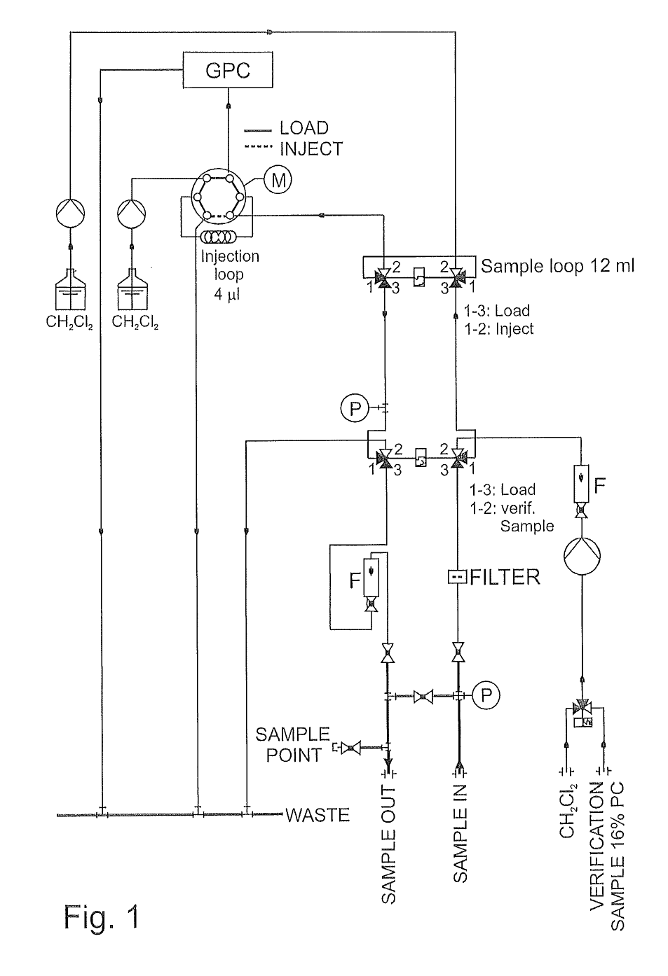

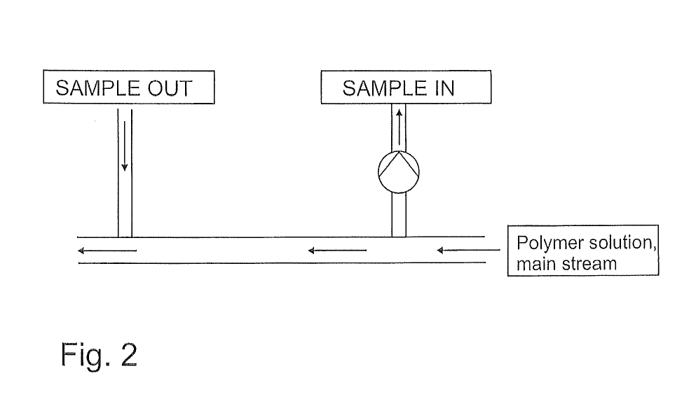

FIG. 1 and FIG. 2 show by way of example a diagram of an experimental system using the concept for sampling and injection. The solution of the polymer requiring measurement in an organic solvent is removed continuously from a component of the process for producing the polymer, where the said polymer solution has been substantially freed from inorganic salts. The solution is subject to superatmospheric pressure which is optionally generated by an additional pump. The substream diverted by way of the sampling line here is continuously introduced into the analytical measurement system and is recirculated here back into the main stream. FIG. 1 shows the removal of the sample and the linkage to the analytical measurement system, inclusive of the sample application system and of the link to the GPC system. FIG. 2 shows the connection between analytical measurement system and the main stream by way of the sampling line.

Removal of a sample takes place by way of a sampling system as follows: the sampling line separates a defined volume by way of a plurality of 3-way valves. The volume that can thus be separated is termed sample loop, and is from 1 to 100 ml (in FIG. 1 by way of example 12 ml). The sample loop is delimited by two 3-way valves set in such a way that either sample flows continuously through the sample loop or the polymer solution located in the sample loop is transferred to the analytical multiway valve. This transfer takes place through use of a further line for pure organic solvent; this line is subject to the superatmospheric pressure generated by a solvent pump and also has connection to one of the 3-way valves. The valve positions for charging polymer solution to the sample loop are designated by “load” in position 1-3 in FIG. 1, and those for the transfer of the sample to the analytical multiway valve are designated by “inject” in position 1-2.

A polymer solution is optionally used for calibration. This is achieved by using a calibration apparatus where the organic solution of a polymer with known M_{w}, molecular weight distribution, ηᵣₑₗ and MVR is pumped into the sampling line from a feed vessel (“Verification sample 16% PC” in FIG. 1) with the aid of a suitable pump, where the polymer concentration in the solution is the same as the concentration of the polymer in the polymer solution from the production process. This calibration sample is optionally admitted by way of a further 3-way valve upstream of the sample loop into the sampling system. In position 1-3, sampling from the production process takes place (designated by “Load” in FIG. 1), and in position 1-2 feed of the calibration sample takes place (designated as “Verif. Sample” in FIG. 1). When feed of the calibration sample takes place, this polymer solution is passed to waste rather than into the main stream.

The apparatus encompasses an analytical multiway valve, which comprises an injection loop for the GPC system, or which has an externally arranged injection loop of a precisely defined volume in the range from 1 to 10 μl. In the case of defined valve positions, a polymer solution requiring measurement flows continuously through an injection loop on transfer of the polymer solution from the sample loop into the injection loop. In another defined valve position, the PC solution requiring measurement and present in the injection loop is forced out of the injection loop by the superatmospheric pressure of a solvent and is conveyed into a line which has connection to the GPC system. In another defined valve position, pure solvent flows continuously through the injection loop, which can thus be flushed, where this flushing solution is collected separately.

The precisely defined volume of the PC solution requiring measurement from the injection loop is through a line from the analytical multiway valve to the GPC system (or the GPC columns) with the aid of the superatmospheric pressure of pure solvent to the ingoing end of the GPC system, which is ready for operation. There is a GPC system, or optionally there are a plurality of GPC systems to be operated in parallel, with all of the necessary equipment for conduct of the gel chromatography measurement process and determination of the gel permeation chromatography data, in particular the variously defined molecular weights M_{w}, Mₙ, Mₚ, M_{z} or D of the polymer from the sample solution.

The various lines, such as the sampling lines, solvent lines, etc., can have temperature control independently of one another, for optimisation in respect of the respective polymer solution requiring determination.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

All references described herein are incorporated by reference for all useful purpose

### EXAMPLES

### Determination of the Calibration Relationships for Polycarbonate

The molecular weight M_{w}, of 15 polycarbonate samples (three samples at each of five different viscosity levels; average values being generated from the three samples at each viscosity level for the calibration relationship) with viscosities in the range ηᵣₑₗ=from 1.250 to 1,34 (to DIN 51562) or, respectively, MVR (to DIN EN ISO 1133 for 300° C. and 1.2 kg) in the range from 4 to 16 [cm³/10 min] and in the range from 22 000 to 34 000 [g/mol] was determined by means of GPC, and the GPC was calibrated with linear PCs having known molecular weight distributions.

### Example 1

The experiment used the apparatus depicted in FIG. 1. A solution comprising 16% by weight of PC in a 1:1 solvent mixture made of dichloromethane (DCM) and monochlorobenzene with the aid of a diaphragm through a stainless steel line which simulated the sampling line. The positions of 2 valves were then changed so that the 16% strength by weight solution located in the sample loop (V=12 ml) was then transferred into the injection loop of the 6-way valve with the aid of a continuously operating HPLC pump, which pumps DCM. The volume of the injection loop was about 4 Once the injection loop had been completely filled with the 16% strength by weight solution, the 6-way valve was switched, and the sample was injected onto the GPC columns by a second HPLC pump, which likewise pumps DCM. Downstream of the GPC columns were a UV detector and a RI detector. The chromatograms were evaluated with the aid of a stored PC calibration system.

Table 1 below shows the result of 6-fold determination of the M_{w} values (with UV detector) and ηᵣₑₗ and MVR values of a sample. The interval between the individual injections was about 48 min. The conversion to give ηᵣₑₗ and MVR values was achieved by using the stored calibration relationships. The standard deviation for M_{w} was ±163 g/mol or 0.6%. The standard deviation for ηᵣₑₗ was ±0.0014. The standard deviation for MVR was ±0.2 [cm³/10 min]. These standard deviations for ηᵣₑₗ and MVR correspond to the accuracy of ηᵣₑₗ determination using an Ubbelohde viscometer and, respectively, MVR determination using melt index testing equipment, and have sufficient accuracy for process monitoring and process control.

TABLE 1

| | | | MVR* |
|---|---|---|---|
| | M_{w} [g/mol] | | calculated |
| | measured | ηᵣₑₗ calculated | from |
| | by GPC | from | correlation |
| Experiment | (UV detector) | correlation | [cm³/10 min] |
| 1 | 27 776 | 1.291 | 8.6 |
| 2 | 28 105 | 1.294 | 8.2 |
| 3 | 27 963 | 1.293 | 8.4 |
| 4 | 27 905 | 1.292 | 8.5 |
| 5 | 27 993 | 1.293 | 8.4 |
| 6 | 28 248 | 1.295 | 8.1 |
| Average value | 27 998 | 1.293 | 8.4 |
| Standard deviation | 163 | 0.0014 | 0.2 |

*to DIN EN ISO 1133 for 300° C. and 1.2 kg

### Example 2

In order to compare the concept of on-line sampling and on-line injection (metering of 4 μl of a solution of strength about 16% by weight) with the established concept of off-line injection systems (injection of 100 μl of a 0.2% strength by weight solution), a second PC solution of strength 16% by weight was first metered by way of the on-line concept described above. The 16% strength by weight PC solution was then diluted with DCM to 0.2% by weight, and 100 μl therefrom were injected, using automatic sample-input equipment. The following results were obtained:

On-line sampling/injection: M_{w}=24052 g/mol
Standard off-line injection system: M_{w}=23874 g/mol

The results can be considered identical within the bounds of accuracy of measurement. This is evidence that the novel sampling and injection concept is suitable for on-line use.

1-11. (canceled)

12. A method for automatically determining the relative solution viscosity and/or the melt volume flow rate of a polymer during a phase of the process for producing the polymer, wherein the polymer is in a solution comprising from 10 to 20% by weight of the polymer in an organic solvent, the method comprising:
a) continuously removing a substream of the polymer solution from a component of the process for producing the polymer, wherein the polymer solution is essentially free from inorganic salts;
b) removing a sample having a volume of from 1 to 10 μl from the substream;
c) introducing the sample into a gel permeation chromatography apparatus and determining the gel permeation chromatography data for the polymer; and
d) automatically determining the relative solution viscosity and/or the melt volume flow rate of the polymer from the data obtained from the gel permeation chromatogram, on the basis of calibration relationships.

13. The method according to claim 12, wherein the substream removed from the polymer solution is returned to the production process.

14. The method according to claim 12, further comprising
introducing a sample having a volume of from 1 to 10 μl of a solution of a further polymer into the gel permeation chromatography apparatus, wherein the gel permeation chromatography data, relative solution viscosity, and melt volume flow rate of the further polymer are known;
determining the gel permeation chromatography data for the further polymer; and
automatically determining the relative solution viscosity and/or the melt volume flow rate of the further polymer from the gel permeation chromatography data determined, on the basis of calibration relationships.

15. The method according to claim 12, wherein the polymer comprises polycarbonate produced by interfacial polycondensation.

16. The method according to claim 12, wherein the gel permeation chromatography data comprises a weight-average molecular weight.

17. The method according to claim 12, wherein the gel permeation chromatography data comprises a number-average molecular weight.

18. The method according to claim 12, wherein the gel permeation chromatography data comprises a molecular weight.

19. An apparatus for determining the relative solution viscosity and/or the melt volume flow rate of a polymer, wherein the polymer is in a solution comprising from 10 to 20% by weight of the polymer in an organic solvent, the apparatus comprising:
a) a sampling line for the solution of the polymer requiring measurement in an organic solvent from a component of the polymer production process,
b) metering equipment for the precision conveying of a sample of the solution of the polymer having a defined volume in the range from 1 to 10 μl;
c) an apparatus for determining gel permeation chromatography data for the polymer; and
d) means for determining the relative solution viscosity and/or the melt volume flow rate of the polymer from the data obtained from the gel permeation chromatogram, on the basis of calibration relationships.

20. The apparatus according to claim 19, further comprising means for removing a substream of a solution comprising from 10 to 20% by weight of the polymer from a process for producing the polymer.

21. The apparatus according to claim 19, further comprising a feed vessel having a solution comprising from 10 to 20% by weight of a further polymer, wherein the gel permeation chromatography data, relative solution viscosity and melt volume flow rate are known, in an organic solvent.

22. The apparatus according to claim 19, wherein the metering equipment comprises a multiway valve which comprises one or more sample loops or a connection to a plurality of sample loops, wherein the metering equipment accurately meters sample volumes in the range from 1 to 10 μl.
